(19) United States
(12) Patent Application Publication
(10) Pub. No.: US 2018/0081287 A1
(43) Pub. Date: Mar. 22, 2018

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Hirofumi NAKAMURA, Kanagawa (JP); Yoshiteru YAMADA, Kanagawa (JP); Yohei SAITO, Kanagawa (JP); Hirohito YONEYAMA, Kanagawa (JP); Kazuhiro KOSEKI, Kanagawa (JP)

(73) Assignee: FUJI XEROX CO., LTD., Tokyo (JP)

(21) Appl. No.: 15/452,181

(22) Filed: Mar. 7, 2017

(30) Foreign Application Priority Data
Sep. 21, 2016 (JP) 2016-184327

(51) Int. Cl. G03G 5/047

(52) U.S. Cl. CPC G03G 5/047; G03G 21/18

(57) ABSTRACT

An electrophotographic photoreceptor includes a conductive substrate and a single-layer-type photosensitive layer on the conductive substrate. The single-layer-type photosensitive layer contains a binder resin, a charge generating material, an electron transporting material, and a hole transporting material. The product of a volume resistivity (GΩ·m) of the single-layer-type photosensitive layer and an elastic modulus (GPa) of the single-layer-type photosensitive layer is about 90 or more.

### CROSS-REFERENCE TO RELATED APPLICATIONS

This application is based on and claims priority under 35 USC 119 from Japanese Patent Application No. 2016-184327 filed Sep. 21, 2016.

### BACKGROUND

### Technical Field

The present invention relates to an electrophotographic photoreceptor, a process cartridge, and an image forming apparatus.

### SUMMARY

According to one aspect of the invention, there is provided an electrophotographic photoreceptor including a conductive substrate and a single-layer-type photosensitive layer on the conductive substrate. The single-layer-type photosensitive layer contains a binder resin, a charge generating material, an electron transporting material, and a hole transporting material. The product of a volume resistivity (GΩ·m) of the single-layer-type photosensitive layer and an elastic modulus (GPa) of the single-layer-type photosensitive layer is 90 or more or about 90 or more.

### BRIEF DESCRIPTION OF THE DRAWINGS

Exemplary embodiments of the present invention will be described in detail based on the following figures, wherein:

FIG. 1 is a schematic partial cross-sectional view of an electrophotographic photoreceptor according to an exemplary embodiment;

FIG. 2 is a schematic diagram illustrating an image forming apparatus according to an exemplary embodiment; and

FIG. 3 is a schematic diagram illustrating an image forming apparatus according to another exemplary embodiment

### DETAILED DESCRIPTION

Exemplary embodiments according to the present invention will now be described in detail.

### Electrophotographic Photoreceptor

An electrophotographic photoreceptor is a positively chargeable organic photoreceptor that includes a conductive substrate and a single-layer-type photosensitive layer on the conductive substrate (hereinafter may be simply referred to as a “photoreceptor” or a “single-layer-type photoreceptor”).

The single-layer-type photosensitive layer contains a binder resin, a charge generating material, an electron transporting material, and a hole transporting material. The product of the volume resistivity (GΩ·m) of the single-layer-type photosensitive layer and the elastic modulus (GPa) of the single-layer-type photosensitive layer is 90 or more or about 90 or more.

Single-layer-type photoreceptors have been used as the electrophotographic photoreceptor from the viewpoints of production cost and image quality stability.

However, when images are repeatedly formed by using a single-layer-type photoreceptor, black spots sometimes occur due to cracking of the photosensitive layer. Occurrence of black spots is particularly noticeable when images are formed in a high-temperature, high-humidity environment.

A photosensitive layer is put under a mechanical load, for example, from a member that presses the photoreceptor. If the elastic modulus of the photosensitive layer is too low, the photosensitive layer easily plastically deforms due to the member that presses the photoreceptor and thus photosensitive layer easily cracks.

Moreover, when images are repeatedly formed in a high-temperature, high-humidity environment, the conductive substrate of the single-layer-type photoreceptor sometimes undergoes corrosion due to the reaction between moisture and the conductive substrate (for example, an aluminum substrate). Corrosion of the conductive substrate is prone to occur when the volume resistivity of the photosensitive layer is low and electric current easily flows into the conductive substrate. When the conductive substrate becomes corroded, protuberances are likely to occur on the surface of the conductive substrate. The photosensitive layer easily cracks due to these protuberances. It has thus been found that the factors involved in occurrence of black spots caused by cracking of the photosensitive layer are the elastic modulus of the photosensitive layer and the volume resistivity of the photosensitive layer.

In this respect, because the photosensitive layer is formed such that the product of the volume resistivity (GΩ·m) and the elastic modulus (GPa) is 90 or more, the photoreceptor according to this exemplary embodiment suppresses occurrence of black spots caused by cracking of the photosensitive layer even when images are repeatedly formed in a high-temperature, high-humidity environment.

When the photosensitive layer has a particular level of elastic modulus, resistance to the mechanical load applied to the photosensitive layer is improved. Moreover, when the photosensitive layer has a particular level of volume resistivity, the electric current flowing from the photosensitive layer to the conductive substrate is suppressed and occurrence of protuberances due to corrosion of the conductive substrate is also suppressed. The elastic modulus and volume resistivity of the photosensitive layer may be high. However, for example, even when the elastic modulus of the photosensitive layer is low, the conductive substrate is less likely to corrode and the cracking of the photosensitive layer is suppressed as long as the volume resistivity of the photosensitive layer is high and the product of the volume resistivity (GΩ·m) and the elastic modulus (GPa) is 90 or more. Even when the volume resistivity of the photosensitive layer is low and the conductive substrate undergoes corrosion and comes to have protuberances thereon, the effect of the protuberances on the photosensitive layer can be easily suppressed as long as the elastic modulus of the photosensitive layer is high and the product of the volume resistivity (GΩ·m) and the elastic modulus (GPa) is 90 or more. As a result, cracks rarely occur in the photosensitive layer and occurrence of black spots attributable to cracking is suppressed.

It is presumed that for the reasons described above, forming a photosensitive layer in such a manner that the product of the volume resistivity (GΩ·m) and the elastic modulus (GPa) is 90 or more suppresses cracking of the photosensitive layer and occurrence of black spots attributable to the cracking of the photosensitive layer even when images are repeated formed in a high-temperature, high-humidity environment.

The electrophotographic photoreceptor according to this exemplary embodiment will now be described in detail with reference to the drawings.

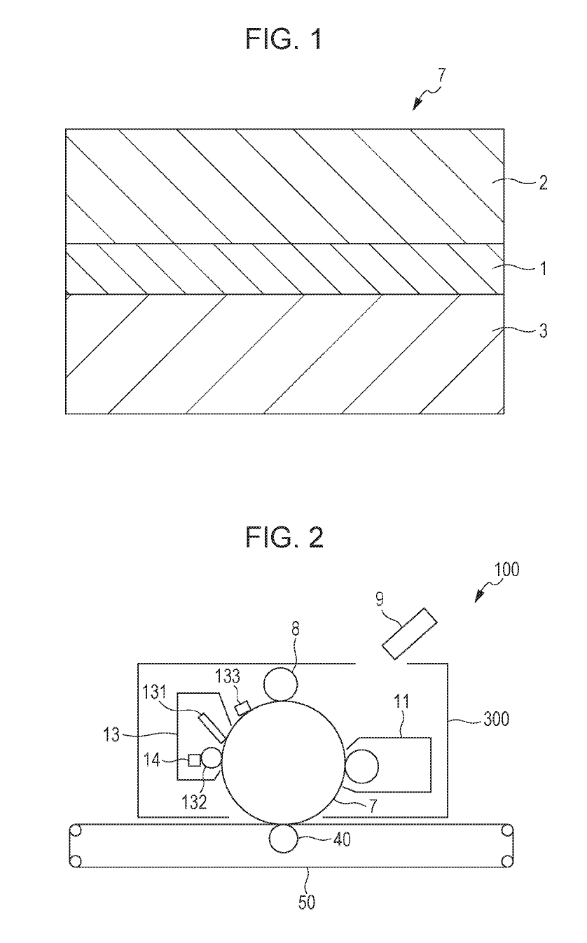

FIG. 1 is a schematic cross-sectional view of a part of an electrophotographic photoreceptor 7 according to the exemplary embodiment.

The electrophotographic photoreceptor 7 includes, for example, a conductive substrate 3, an undercoat layer 1 on the conductive substrate 3, and a single-layer-type photosensitive layer 2 on the undercoat layer 1.

The undercoat layer 1 is an optional layer. In other words, the single-layer-type photosensitive layer 2 may be directly formed on the conductive substrate 3 or the undercoat layer 1 may be disposed between the single-layer-type photosensitive layer 2 and the conductive substrate 3.

Other layers may also be provided as needed.

Specifically, a protective layer may be formed on the single-layer-type photosensitive layer 2 as needed, for example.

Each of the layers of the electrophotographic photoreceptor according to the exemplary embodiment will now be described in detail. Reference numerals are omitted in the description below.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steels etc.), and paper sheets, resin films, and belts having coatings formed by application, vapor deposition, or laminating using conductive compounds (for example, conductive polymers and indium oxide), metals (for example, aluminum, palladium, and gold), or alloys. The term “conductive” means that the volume resistivity is less than 10¹³ Ωcm.

When the electrophotographic photoreceptor is to be used in a laser printer, the surface of the conductive substrate may be roughened to a center-line-average roughness Ra of 0.04 μm or more and 0.5 μm or less in order to suppress interference fringes during laser beam irradiation. When an incoherent light is used as a light source, roughening is not particularly needed for the purpose of preventing interference fringes but may be performed to obtain a longer service life since defects caused by irregularities on the surface of the conductive substrate are reduced.

Examples of the roughening method include wet honing that involves spraying a suspension of an abrasive in water onto the conductive substrate, centerless grinding that involves continuously grinding the conductive substrate by pressing the conductive substrate against a rotating grinding stone, and anodization.

Another example of a method for obtaining a rough surface involves forming a layer containing a resin and dispersed conductive or semi-conductive particles on a surface of the conductive substrate so that the particles dispersed in the layer create roughness. According to this method, the surface of the conductive substrate is not directly roughened.

Roughening by anodization involves conducting anodization by using a metal (e.g., aluminum) conductive substrate as the anode in an electrolytic solution so as to form an oxide film on the surface of the conductive substrate. Examples of the electrolytic solution include a sulfuric acid solution and an oxalic acid solution. However, the anodized film formed by anodization is porous, and is thus chemically active and susceptible to contamination as is. Moreover, the resistance thereof fluctuates depending on the environment. Thus the porous anodized film may be subjected to a pore stopping treatment with which the fine pores of the oxide film are stopped by volume expansion caused by hydration reaction in compressed steam or boiling water (a metal salt such as a nickel salt may be added) so as to convert the oxide into a more stable hydrous oxide.

The thickness of the anodized film may be, for example, 0.3 μm or more and 15 μm or less. When the thickness is in this range, the anodized film has a tendency of exhibiting a barrier property against injection. Moreover, the increase in residual potential due to repeated use tends to be suppressed.

The conductive substrate may be treated with an acidic treatment solution or subjected to a Boehmite treatment.

The treatment with an acidic treatment solution is, for example, carried out as follows. First, an acidic treatment solution containing phosphoric acid, chromic acid, and hydrofluoric acid is prepared. The blend ratios of phosphoric acid, chromic acid, and hydrofluoric acid in the acidic treatment solution are, for example, phosphoric acid: 10% by weight or more and 11% by weight or less, chromic acid: 3% by weight or more and 5% by weight or less, and hydrofluoric acid: 0.5% by weight or more and 2% by weight or less. The total acid concentration may be 13.5% by weight or more and 18% by weight or less. The treatment temperature may be, for example, 42° C. or higher and 48° C. or lower. The thickness of the coating film may be 0.3 μm or more and 15 μm or less.

The Boehmite treatment is conducted, for example, by immersing the conductive substrate in pure water at 90° C. or higher and 100° C. or lower for from 5 minutes to 60 minutes or bringing the conductive substrate into contact with hot compressed steam at 90° C. or higher and 120° C. or lower for from 5 minutes to 60 minutes. The thickness of the film may be 0.1 μm or more and 5 μm or less. The resulting conductive substrate may be further subjected to an anodization treatment by using an electrolytic solution that has a low film dissolving power, such as adipic acid, boric acid, borate, phosphate, phthalate, maleate, benzoate, tartrate, or citrate.

### Treatment Using an Amino-Containing Silane Coupling Agent

The conductive substrate may be an amino-containing silane coupling agent-treated conductive substrate obtained by surface-treating a conductive substrate with a silane coupling agent containing an amino-containing silane coupling agent from the viewpoint of further suppressing occurrence of black spots due to cracking of the photosensitive layer.

When the conductive substrate is an amino-containing silane coupling agent-treated conductive substrate, charge injection from the conductive substrate to the photosensitive layer is more easily suppressed. When a photosensitive layer whose product of the volume resistivity and elastic modulus is 90 or more is formed on the amino-containing silane coupling agent-treated conductive substrate, occurrence of black spots due to cracking of the photosensitive layer is further suppressed. This is presumably attributable to a synergetic effect of the conductive substrate and the photosensitive layer.

The amino-containing silane coupling agent-treated conductive substrate may be surface-treated with an amino-containing silane coupling agent alone or a silane coupling agent containing an amino-containing silane coupling agent and an amino-free silane coupling agent. From the viewpoint of further suppressing occurrence of black spots due to cracking of the photosensitive layer, the amino-containing silane coupling agent-treated conductive substrate may be one obtained by surface treatment with an amino-containing silane coupling agent alone.

When an amino-containing silane coupling agent and an amino-free silane coupling agent are used in combination, the amino-containing silane coupling agent may account for 50% by weight or more of the total weight of the silane coupling agents.

Examples of the amino-containing silane coupling agent used for surface treatment of the conductive substrate include, but are not limited to, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane.

These amino-containing silane coupling agents may be used alone or in combination.

Examples of the amino-free silane coupling agent include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, and 3-chloropropyltrimethoxysilane.

The amino-containing silane coupling agent-treated conductive substrate is obtained by, for example, applying a solution or suspension containing an amino-containing silane coupling agent through a spray coating method, a roll coating method, a dip coating method, or any other known coating method. After application, if needed, heat treatment (baking) may be conducted. Examples of the heat treatment conditions are a heat treatment temperature of 150° C. or higher and 300° C. or lower and a heat treatment time of 30 minutes or longer and 5 hours or shorter.

The thickness of the amino-containing silane coupling agent-treated film of the amino-containing silane coupling agent-treated conductive substrate may be, for example, 1 μm or more and 200 μm or less (or 2 μm or more and 100 μm or less).

Whether the conductive substrate is surface-treated with an amino-containing silane coupling agent is confirmed through a molecular structure analysis such as Fourier transform-infrared spectroscopy (FT-IR), Raman spectroscopy, or X-ray photoelectron spectroscopy (XPS).

### Undercoat Layer

The undercoat layer is, for example, a layer that contains inorganic particles and a binder resin.

Examples of the inorganic particles are those having a powder resistance (volume resistivity) of 10² Ωcm or more and 10¹¹ Ωcm or less.

Examples of the inorganic particles having such resistivity include metal oxide particles such as tin oxide particles, titanium oxide particles, zinc oxide particles, and zirconium oxide particles. Zinc oxide particles may be used as the inorganic particles.

The BET specific surface area of the inorganic particles may be, for example, 10 m²/g or more.

The volume-average particle size of the inorganic particles may be, for example, 50 nm or more and 2000 nm or less or 60 nm or more and 1000 nm or less.

The inorganic particle content relative to, for example, the binder resin may be 10% by weight or more and 80% by weight or less or may be 40% by weight or more and 80% by weight or less.

The inorganic particles may have treated surfaces. A mixture of two or more types of inorganic particles subjected different surface treatments or having different particle sizes may be used.

Examples of the surface treatment agent include a silane coupling agent, a titanate coupling agent, an aluminum coupling agent, and a surfactant. In particular, a silane coupling agent or, to be more specific, an amino-containing silane coupling agent may be used.

Examples of the amino-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be used in combination. For example, a combination of an amino-containing silane coupling agent and another silane coupling agent may be used. Examples of this another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using the surface treatment agent may be any known method and may be a wet method or a dry method.

The amount of the surface treatment agent used may be 0.5% by weight or more and 10% by weight or less relative to the inorganic particles, for example.

The undercoat layer may contain an electron accepting compound (acceptor compound) as well as inorganic particles. This is because long-term stability of electric properties and the carrier blocking property are enhanced.

Examples of the electron accepting compounds include electron transporting substances such as quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; and diphenoquinone compounds such as 3,3′,5,5′-tetra-t-butyldiphenoquinone.

A compound having an anthraquinone structure may be used as the electron-accepting compound. Examples of the compound having an anthraquinone structure include hydroxyanthraquinone compounds, aminoanthraquinone compounds, and aminohydroxyanthraquinone compounds. Specific examples thereof include anthraquinone, alizarin, quinizarin, anthrarufin, and purpurin.

The electron accepting compound may be co-dispersed with the inorganic particles in the undercoat layer. Alternatively, the electron accepting compound may be attached to the surfaces of the inorganic particles and contained in the undercoat layer.

A method for causing the electron accepting compound to attach to the surfaces of the inorganic particles may be a dry method or a wet method.

According to a dry method, for example, while inorganic particles are stirred with a mixer or the like having a large shear force, an electron accepting compound as is or dissolved in an organic solvent is dropped or sprayed along with dry air or nitrogen gas so as to cause the electron accepting compound to attach to the surfaces of the inorganic particles. When the electron accepting compound is dropped or sprayed, the temperature may be not higher than the boiling point of the solvent. After the electron accepting compound is dropped or sprayed, baking may be further conducted at 100° C. or higher. Baking may be conducted at any temperature for any amount of time as long as electrophotographic properties are obtained.

According to a wet method, while inorganic particles are dispersed in a solvent through stirring or by using ultrasonic waves, a sand mill, an attritor, a ball mill, or the like, an electron accepting compound is added thereto and the resulting mixture is stirred or dispersed, followed by removal of the solvent to cause the electron accepting compound to attach to the surfaces of the inorganic particles. The solvent is removed by, for example, filtration or distillation. After removal of the solvent, baking may be conducted at 100° C. or higher. Baking may be conducted at any temperature for any amount of time as long as electrophotographic properties are obtained. In the wet method, the water contained in the inorganic particles may be removed prior to adding the electron accepting compound. For example, water may be removed by stirring the inorganic compound in a solvent under heating or azeotropically with the solvent.

The electron accepting compound may be attached to the inorganic particles before, after, or at the same time as treating the surface with a surface treatment agent.

The electron accepting compound content relative to, for example, the inorganic particles may be 0.01% by weight or more and 20% by weight or less or 0.01% by weight or more and 10% by weight or less.

Examples of the binder resin used in the undercoat layer include known polymer materials such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; and other known materials such as zirconium chelate compounds, titanium chelate compounds, aluminum chelate compounds, titanium alkoxide compounds, organic titanium compounds, and silane coupling agents.

Other examples of the binder resin used in the undercoat layer include a charge transporting resin having a charge transporting group and a conductive resin (e.g., polyaniline).

Among these, a resin insoluble in the coating solvent contained in the overlying layer may be used as the binder resin contained in the undercoat layer. Examples thereof include thermosetting resins such as urea resins, phenolic resins, phenol-formaldehyde resins, melamine resins, urethane resins, unsaturated polyester resins, alkyd resins, and epoxy resins; and resins obtained by reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin.

When two or more of these binder resins are used in combination, the mixing ratio is set as desired.

The undercoat layer may contain various additives that improve electrical properties, environmental stability, and image quality.

Examples of the additives include known materials such as electron transporting pigments based on fused polycyclic and azo materials, zirconium chelate compounds, titanium chelate compounds, aluminum chelate compounds, titanium alkoxide compounds, organic titanium compounds, and silane coupling agents. Although a silane coupling agent is used in a surface treatment of inorganic particles as discussed above, it may also be added to the undercoat layer as an additive.

Examples of the silane coupling agent used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, zirconium acetylacetonate butoxide, zirconium ethyl acetoacetate butoxide, zirconium acetate, zirconium oxalate, zirconium lactate, zirconium phosphonate, zirconium octanoate, zirconium naphthenate, zirconium laurate, zirconium stearate, zirconium isostearate, zirconium methacrylate butoxide, zirconium stearate butoxide, and zirconium isostearate butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, and polyhydroxytitanium stearate.

Examples of the aluminum chelate compounds include aluminum isopropylate, monobutoxyaluminum diisopropylate, aluminum butylate, diethylacetoacetate aluminum diisopropylate, and aluminum tris(ethyl acetoacetate).

These additives may be used alone or as a mixture or a polycondensation product of two or more compounds.

The undercoat layer may have a Vickers hardness of 35 or more.

The surface roughness (ten-point average roughness) of the undercoat layer may be adjusted to 1/(4n) (n: refractive index of overlying layer) to ½ of the exposure laser wavelength λ in order to suppress moire images.

Resin particles and the like may be added to the undercoat layer to adjust the surface roughness. Examples of the resin particles include silicone resin particles and crosslinked polymethyl methacrylate resin particles. The surface of the undercoat layer may be polished to adjust the surface roughness. Examples of the polishing method include buff polishing, sand blasting, wet honing, and grinding.

The undercoat layer may be formed by any known method. For example, a coating solution for forming an undercoat layer may be prepared by adding the above-described components to a solvent, forming a coating film by using this coating solution, drying the coating film, and, if needed, heating the coating film.

Examples of the solvent used to prepare the coating solution for forming an undercoat layer include known organic solvents such as alcohol solvents, aromatic hydrocarbon solvents, halogenated hydrocarbon solvents, ketone solvents, ketone alcohol solvents, ether solvents, and ester solvents.

Specific examples of these solvents include ordinary organic solvents such as methanol, ethanol, n-propanol, isopropanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing inorganic particles in preparing the coating solution for forming an undercoat layer include known methods that use a roll mill, a ball mill, a vibrating ball mill, an attritor, a sand mill, a colloid mill, and a paint shaker.

Examples of the method for applying the coating solution for forming an undercoat layer onto the conductive substrate include known methods such as a blade coating method, a wire bar coating method, a spray coating method, a dip coating method, a bead coating method, an air knife coating method, and a curtain coating method.

The thickness of the undercoat layer may be set to 15 μm or more, or may be set to 20 μm or more and 50 μm or less.

### Intermediate Layer

An intermediate layer may be formed between the undercoat layer and the photosensitive layer although this is not illustrated in the drawings.

The intermediate layer is, for example, a layer that contains a resin. Examples of the resin contained in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer that contains an organic metal compound. Examples of the organic metal compound contained in the intermediate layer include organic metal compounds containing metal atoms such as zirconium, titanium, aluminum, manganese, and silicon atoms.

These compounds to be contained in the intermediate layer may be used alone or as a mixture or a polycondensation product of two or more compounds.

The intermediate layer may be a layer that contains an organic compound that contains a zirconium atom or a silicon atom, in particular.

The intermediate layer may be formed by any known method. For example, a coating solution for forming the intermediate layer may be prepared by adding the above-described components to a solvent and applied to form a coating film, and the coating film may be dried and, if desired, heated.

Examples of the method for applying the solution for forming the intermediate layer include known methods such as a dip coating method, a lift coating method, a wire bar coating method, a spray coating method, a blade coating method, a knife coating method, and a curtain coating method.

The thickness of the intermediate layer is, for example, set within the range of 0.1 μm or more and 3 μm or less. The intermediate layer may be used as an undercoat layer.

### Single-Layer-Type Photosensitive Layer

The single-layer-type photosensitive layer contains a binder resin, a charge generating material, an electron transporting material, and a hole transporting material. The single-layer-type photosensitive layer may further contain other additives if needed.

### Product of Volume Resistivity and Elastic Modulus

The product of the volume resistivity (GΩ·m) of the photosensitive layer and the elastic modulus (GPa) of the photosensitive layer is 90 or more, and may be 95 or more or about 95 or more in some cases and 100 or more in some cases.

The product of the volume resistivity (GΩ·m) and the elastic modulus (GPa) is the product of the volume resistivity divided by 10⁹ and the elastic modulus divided by 10⁹. For example, when the volume resistivity is 30 (GΩ·m) and the elastic modulus is 3 (GPa), the product is 90.

The elastic modulus of the photosensitive layer may be 4.0 (GPa) or more or about 4.0 (GPa) or more (or may be 4.3 (GPa) or more in some cases and 4.5 (GPa) or more in some cases). The upper limit of the elastic modulus is not particularly limited and may be, for example, 6 (GPa) or less.

The elastic modulus of the photosensitive layer is measured as follows.

A part of the photosensitive layer of the photoreceptor to be measured is cut out with a cutter or the like into a measurement sample 5 mm×20 mm in size. If a protective layer is provided, the protective layer is separated first and the photosensitive layer is exposed.

The measurement sample is analyzed with a viscoelasticity meter DMS produced by Seiko Instruments Inc., under the following conditions:

Measurement environment: 40° C.

### Frequency: 0.5 Hz

The elastic modulus of the photosensitive layer can be controlled by adjusting the material for forming the photosensitive layer, the composition of the photosensitive layer, etc.

The volume resistivity of the photosensitive layer may be 20 (GΩ·m) or more or about 20 (GΩ·m) or more (or may be 21 (GΩ·m) or more in some cases and 23 (GΩ·m) or more in some cases). The upper limit of the volume resistivity is not particularly limited and may be, for example, 50 (GΩ·m) or less.

The volume resistivity of the single-layer-type photosensitive layer is determined as follows.

The photosensitive layer is cut out from an electrophotographic photoreceptor to be measured so as to obtain a measurement sample. Aluminum electrodes (electrode area: 1 cm²) are attached to the measurement sample. In an environment at a temperature of 22° C. and a humidity of 55% RH, a voltage is applied by using a frequency response analyzer (model 1260 produced by Solartron Analytical) for 30 seconds under dark conditions so that the electric field (applied voltage/measurement sample thickness) is 10 V/μm. Then the current value (A) of the current flowing therein is measured. The current value is substituted into the following equation:

volume resistivity (GΩ·m)=(10⁻⁴ (m²)×applied voltage (V))/(current value (A)×measurement sample thickness (m)) Equation:

The volume resistivity of the photosensitive layer can be controlled by, for example, adjusting the composition of the photosensitive layer, the drying temperature of drying the coating film of a photosensitive layer-forming coating solution, the thickness of the photosensitive layer, etc.

### Binder Resin

The binder resin may be any binder resin. Examples thereof include polycarbonate resins (homopolymer types such as bisphenol A, bisphenol Z, bisphenol C, and bisphenol TP, or copolymers thereof), polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilane. These binder resins may be used alone or in combination.

Among these binder resins, a polycarbonate resin having a viscosity-average molecular weight of 30,000 or more and 80,000 or less, for example, may be used.

The viscosity-average molecular weight of the polycarbonate resin is measured by, for example, the following method. In 100 cm³ of methylene chloride, 1 g of the resin is dissolved. The specific viscosity ηsp of the resulting solution is measured with a Ubbelohde viscometer in a 25° C. measurement environment. The limiting viscosity [η] (cm³/g) is determined from the expression ηsp/c=[η]+0.45[η]²c (where c represents the concentration (g/cm³)), and the viscosity-average molecular weight My is determined from the expression given by H. Schnell, [η]=1.23×10⁻⁴Mv^{0.83}.

The binder resin content relative to the total solid content in the photosensitive layer may be 35% by weight or more and 65% by weight or less, 40% by weight or more and 60% by weight or less in some cases, and 45% by weight or more and 55% by weight or less in some cases.

Examples of the polycarbonate resin include homopolymer-type polycarbonate resins having bisphenol skeletons such as bisphenol A, bisphenol Z, bisphenol C, and bisphenol TP; and biphenyl-copolymer-type polycarbonate resins that have these bisphenol skeletons and biphenyl skeletons. From the viewpoints of controlling the elastic modulus of the photosensitive layer and suppress cracking of the photosensitive layer, a biphenyl-copolymer-type polycarbonate resin (hereinafter may also be referred to as a “BP polycarbonate resin”) may be used.

A BP polycarbonate resin may have a structural unit represented by general formula (PCA) below and a structural unit represented by general formula (PCB) below:

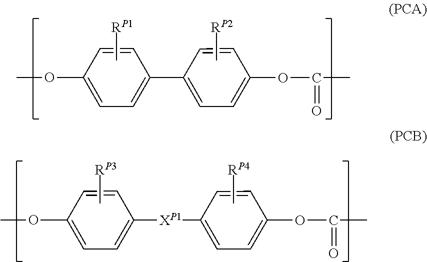

In general formulae (PCA) and (PCB), R^{P1}, R^{P2}, R^{P3}, and R^{P4} each independently represent a hydrogen atom, a halogen atom, an alkyl group having from 1 to 6 carbon atoms, a cycloalkyl group having from 5 to 7 carbon atoms, or an aryl group having from 6 to 12 carbon atoms. X^{P1} represents a phenylene group, a biphenylene group, a naphthylene group, an alkylene group, or a cycloalkylene group.

Examples of the alkyl groups represented by R^{P1}, R^{P2}, R^{P3}, and R^{P4} in general formulae (PCA) and (PCB) include straight-chain or branched alkyl groups having from 1 to 6 carbon atoms (or from 1 to 3 carbon atoms in some cases).

Specific examples of the straight-chain alkyl group include a methyl group, an ethyl group, a n-propyl group, a n-butyl group, a n-pentyl group, and a n-hexyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, and a tert-hexyl group.

The alkyl group may be a lower alkyl group such as a methyl group or an ethyl group among these alkyl groups.

Examples of the cycloalkyl groups represented by R^{P1}, R^{P2}, R^{P3}, and R^{P4} in general formulae (PCA) and (PCB) include cyclopentyl, cyclohexyl, and cycloheptyl.

Examples of the aryl group represented by R^{P1}, R^{P2}, R^{P3}, and R^{P4} in general formulae (PCA) and (PCB) include a phenyl group, a naphthyl group, and a biphenylyl group.

Examples of the alkylene group represented by X^{P1} in general formula (PCB) include straight-chain or branched alkylene groups having from 1 to 12 carbon atoms (or from 1 to 6 carbon atoms in some cases and from 1 to 3 carbon atoms in some cases).

Specific examples of the straight-chain alkylene group include a methylene group, an ethylene group, a n-propylene group, a n-butylene group, a n-pentylene group, a n-hexylene group, a n-heptylene group, a n-octylene group, a n-nonylene group, a n-decylene group, a n-undecylene group, and n-dodecylene group.

Specific examples of the branched alkylene group include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isoundecylene group, a sec-undecylene group, a tert-undecylene group, a neoundecylene group, an isododecylene group, a sec-dodecylene group, a tert-dodecylene group, and a neododecylene group.

Among these, lower alkyl groups such as a methylene group, an ethylene group, and a butylene group may be used as the alkylene group.

Examples of the cycloalkylene group represented by X^{P1} in general formula (PCB) include cycloalkylene groups having from 3 to 12 carbon atoms (or from 3 to 10 carbon atoms in some cases and 5 to 8 carbon atoms in some cases).

Specific examples of the cycloalkylene group include a cyclopropylene group, a cyclopentylene group, a cyclohexylene group, a cyclooctylene group, and a cyclododecanylene group.

Among these, a cyclohexylene group may be used as the cycloalkylene group.

The substituents represented by R^{P1}, R^{P2}, R^{P3}, R^{P4}, and X^{P1} in general formulae (PCA) and (PCB) include groups that also have substituents. Examples of the substituents include halogen atoms (for example, a fluorine atom and a chlorine atom), alkyl groups (for example, an alkyl group having from 1 to 6 carbon atoms), cycloalkyl groups (for example, a cycloalkyl group having from 5 to 7 carbon atoms), alkoxy groups (for example, an alkoxy group having from 1 to 4 carbon atoms), and aryl groups (for example, a phenyl group, a naphthyl group, and a biphenylyl group).

In general formula (PCA), R^{P1} and R^{P2} may each independently represent a hydrogen atom or an alkyl group having from 1 to 6 carbon atoms in some cases or a hydrogen atom in some cases.

In general formula (PCB), R^{P3} and R^{P4} may each independently represent a hydrogen atom or an alkyl group having from 1 to 6 carbon atoms and X^{P1} may represent an alkylene group or a cycloalkylene group.

Specific examples of the BP polycarbonate resin include, but are not limited to, those example compounds described below (note that pm and pn in the example compounds represent copolymerization ratios):

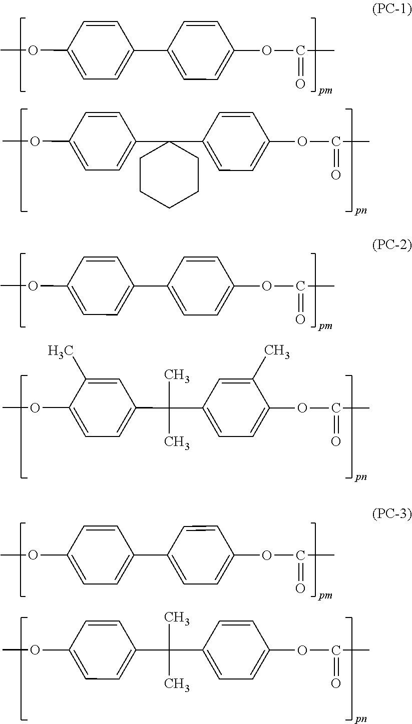

In the BP polycarbonate resin, the proportion (copolymerization ratio) of the structural unit represented by general formula (PCA) may be in the range of 5% by mol or more and 95% by mol or less, 5% by mol or more and 50% by mol or less, or 15% by mol or more and 30% by mol or less relative to all structural units constituting the BP polycarbonate resin.

Specifically, in the example compounds of the BP polycarbonate resins described above, pm and pn representing the copolymerization ratios (molar ratios) may satisfy pm:pn=95:5 to 5:95, 50:50 to 5:95, or 15:85 to 30:70.

### Charge Generating Material

No limits are imposed on the charge generating material. Examples of the charge generating material include a hydroxygallium phthalocyanine pigment, a chlorogallium phthalocyanine pigment, a titanyl phthalocyanine pigment, and a metal-free phthalocyanine pigment. These charge generating materials may be used alone or in combination. Among these, at least one selected from a hydroxygallium phthalocyanine pigment and chlorogallium phthalocyanine pigment may be used from the viewpoint of enhancing the sensitivity of the photoreceptor. The two pigments may be used alone or in combination. From the same viewpoint, a hydroxygallium phthalocyanine pigment, in particular, a type-V hydroxygallium phthalocyanine pigment, may be used.

In particular, a hydroxygallium phthalocyanine pigment having a maximum peak wavelength in the range of 810 nm or more and 839 nm or less in an absorption spectrum in the wavelength range of 600 nm or more and 900 nm or less may be used as the hydroxygallium phthalocyanine pigment in order to obtain excellent dispersibility. When this is used as the material for the electrophotographic photoreceptor, excellent dispersibility, satisfactory sensitivity, chargeability, and dark decay characteristics are easily obtained.

The hydroxygallium phthalocyanine pigment, which has a maximum peak wavelength in the range of 810 nm or more and 839 nm or less, may have an average particle size in a particular range and a BET specific surface area in a particular range. Specifically, the average particle size may be 0.20 μm or less or may be 0.01 μm or more and 0.15 μm or less. The BET specific surface area may be 45 m²/g or more or may be 50 m²/g or more. In other cases, the BET specific surface area may be 55 m²/g or more and 120 m²/g or less. The average particle size is a volume-average particle size (d50 average particle diameter) measured with a laser diffraction scattering particle size distribution meter (LA-700 produced by Horiba Ltd.). The BET specific surface area is a value measured by a nitrogen substitution method using a BET specific surface area analyzer (FlowSorb 112300 produced by Shimadzu Corporation).

When the average particle size is greater than 0.20 μm or the specific surface area is less than 45 m²/g, the pigment particles may be coarse or aggregates of the pigment particles may have formed. As a result, properties such as dispersibility, sensitivity, chargeability, and dark decay characteristics may be degraded and image quality defects may occur.

The maximum particle size (maximum value of primary particle diameter) of the hydroxygallium phthalocyanine pigment may be 1.2 μm or less, 1.0 μm or less, or 0.3 μm or less.

The hydroxygallium phthalocyanine pigment may have an average particle size of 0.2 μm or less, a maximum particle size of 1.2 μm or less, and a specific surface area of 45 m²/g or more.

The hydroxygallium phthalocyanine pigment may be a type V hydroxygallium phthalocyanine pigment that has diffraction peaks at Bragg's angles (2θ±0.2°) of at least 7.3°, 16.0°, 24.9°, and 28.0° in an X-ray diffraction spectrum taken with a Cu Kα ray.

The chlorogallium phthalocyanine pigment may be a compound having diffraction peaks at Bragg's angles (2θ±0.2° of 7.4°, 16.6°, 25.5°, and 28.3° from the viewpoint of sensitivity of the photosensitive layer. The maximum peak wavelength, average particle size, maximum particle size, and BET specific surface area of the chlorogallium phthalocyanine pigment may be the same as those of the hydroxygallium phthalocyanine pigment.

The charge generating material content relative to the total solid content of the photosensitive layer may be 0.5% by weight or more and 5% by weight or less or may be 1.2% by weight or more and 4.5% by weight or less.

### Hole Transporting Material

No limitations are imposed on the hole transporting material. Examples thereof include oxadiazole derivatives such as 2,5-bis(p-diethylaminophenyl)-1,3,4-oxadiazole; pyrazoline derivatives such as 1,3,5-triphenyl-pyrazoline and 1-[pyridyl-(2)]-3-(p-diethylaminostyryl)-5-(p-diethylaminostyryl)pyrazoline; aromatic tertiary amino compounds such as triphenylamine, N,N′-bis(3,4-dimethylphenyl)biphenyl-4-amine, tri(p-methylphenyl)aminyl-4-amine, and dibenzylaniline; aromatic tertiary diamino compounds such as N,N′-bis(3-methylphenyl)-N,N′-diphenylbenzidine; 1,2,4-triazine derivatives such as 3-(4′-dimethylaminophenyl)-5,6-di-(4′-methoxyphenyl)-1,2,4-triazine; hydrazone derivatives such as 4-diethylaminobenzaldehyde-1, 1-diphenylhydrazone; quinazoline derivatives such as 2-phenyl-4-styryl-quinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives, carbazole derivatives such as N-ethylcarbazole; poly-N-vinylcarbazole and its derivatives; and a polymer having a group containing any one of the above-described compounds in a main chain or a side chain. These hole transporting materials may be used alone or in combination.

Specific examples of the hole transporting material include compounds represented by general formula (B-1) below, compounds represented by general formula (B-2) below, and compounds represented by general formula (B-3 below.

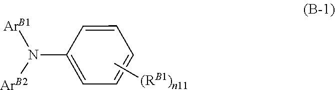

In general formula (B-1), R^{B1} represents a hydrogen atom or a methyl group; n11 represents 1 or 2; Ar^{B1} and Ar^{B2} each independently represent a substituted or unsubstituted aryl group, —C₆H₄—C(R^{B3})═C(R^{B4})(R^{B5}), or —C₆H₄—CH═CH—CH═C(R^{B6})(R^{B7}); and R^{B3} to R^{B7} each independently represent a hydrogen atom, a substituted or unsubstituted alkyl group, or a substituted or unsubstituted aryl group. Examples of the substituent include halogen atoms, alkyl groups having from 1 to 5 carbon atoms, alkoxy groups having from 1 to 5 carbon atoms, and substituted amino groups substituted with alkyl groups having from 1 to 3 carbon atoms.

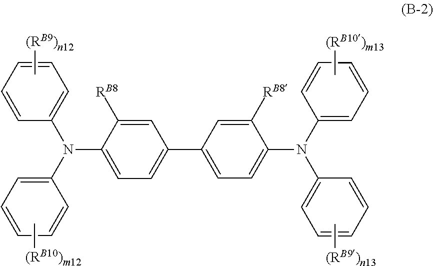

In general formula (B-2), R^{B8} and R^{B8′} may be the same or different and each independently represent a hydrogen atom, a halogen atom, an alkyl group having from 1 to 5 carbon atoms, or an alkoxy group having from 1 to 5 carbon atoms; R^{B9}, R^{B9′}, R^{B10}, and RB^{10′} may be the same or different and each independently represent a halogen atom, an alkyl group having from 1 to 5 carbon atoms, an alkoxy group having from 1 to 5 carbon atoms, an amino group substituted with an alkyl group having from 1 or 2 carbon atoms, a substituted or unsubstituted aryl group, —C(R^{B11})═C(R^{B12})(R^{B13}), or —CH═CH—CH═C(R^{B14})(R^{B15}) where R^{B11} to R^{B15} each independently represent a hydrogen atom, a substituted or unsubstituted alkyl group, or a substituted or unsubstituted aryl group, and m12, m13, n12, and n13 each independently represent an integer of 0 or more and 2 or less.

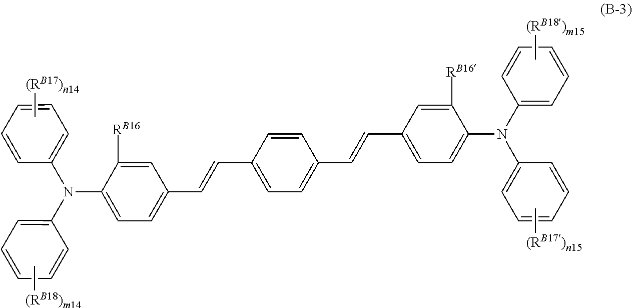

In general formula (B-3), RB¹⁶ and RB^{16′} may be the same or different and each independently represent a hydrogen atom, a halogen atom, an alkyl group having from 1 to 5 carbon atoms, or an alkoxy group having from 1 to 5 carbon atoms; RB¹⁷, RB^{17′}, RB¹⁸, and RB^{18′} may be the same or different and each independently represent a halogen atom, an alkyl group having from 1 to 5 carbon atoms, an alkoxy group having from 1 to 5 carbon atoms, an amino group substituted with an alkyl group having 1 or 2 carbon atoms, a substituted or unsubstituted aryl group, —C(RB¹⁹)═C(RB²⁰)(RB²¹), or —CH═CH—CH═C(RB²²)(RB²³) where RB¹⁹ to RB²³ each independently represent a hydrogen atom, a substituted or unsubstituted alkyl group, or a substituted or unsubstituted aryl group, and m14, m15, n14, and n15 each independently represent an integer of 0 or more and 2 or less.

Among the compounds represented by general formula (B-1), the compounds represented by general formula (B-2), and the compound represented by general formula (B-3), a compound represented by general formula (B-1) having “—C₆H₄—CH═CH—CH═C(RB⁶)(RB⁷)” and a compound represented by general formula (B-2) having “—CH═CH—CH═C(RB¹⁴)(RB¹⁵)” may be used.

Specific examples of the hole transporting material include, but are not limited to, those represented by structural formulae (HT-1) to (HT-12) below.

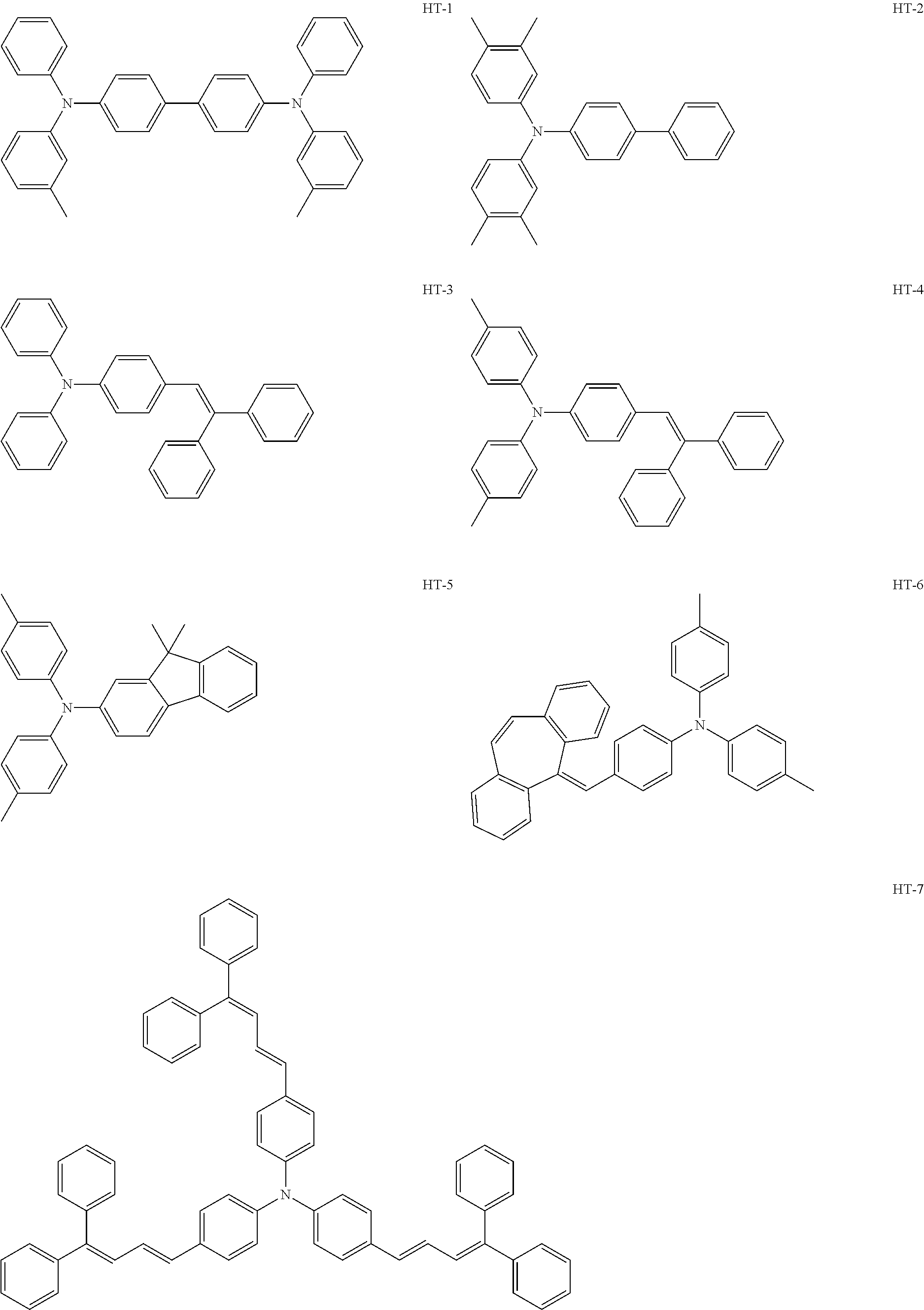

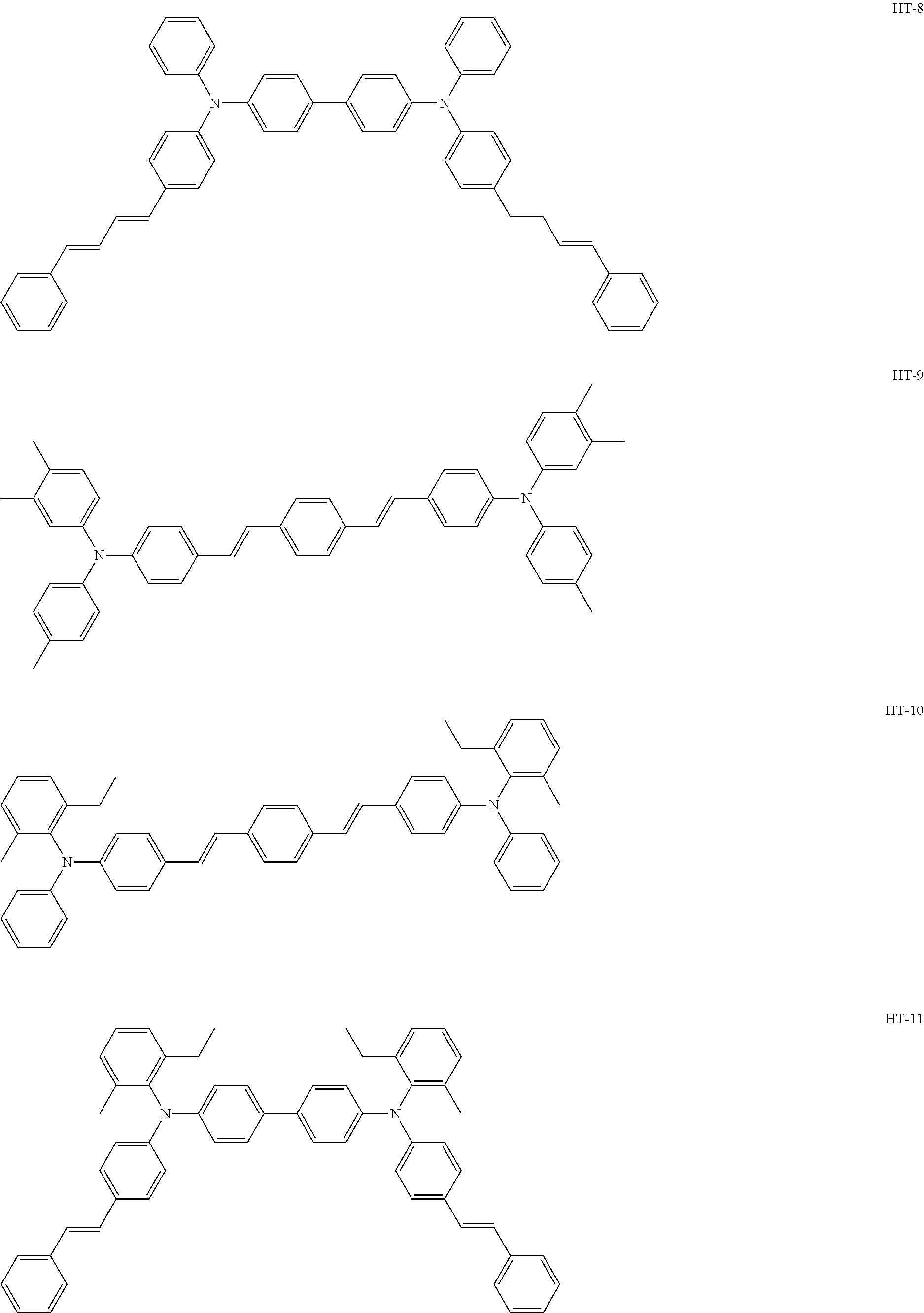

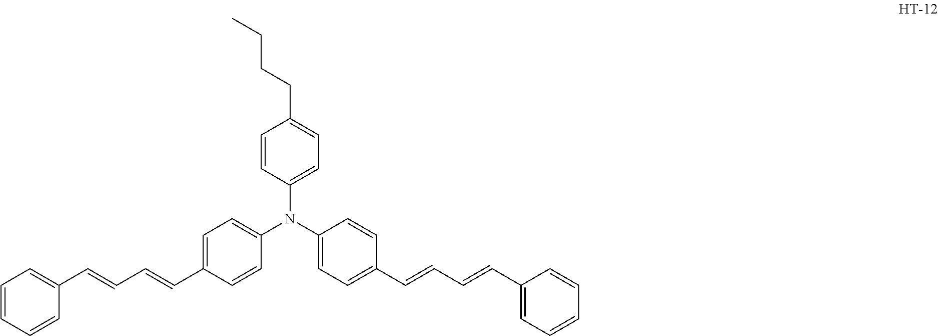 [SMILES: CCCCc1ccc(N(c2ccc(/C=C/C=C/c3ccccc3)cc2)c2ccc(/C=C/C=C/c3ccccc3)cc2)cc1]

The total hole transporting material content relative to the total solid content of the photosensitive layer may be 10% by weight or more and 45% by weight or less, 20% by weight or more and 38% by weight or less, or 30% by weight or more and 38% by weight or less.

### Electron Transporting Material

No limitations are imposed on the electron transporting material. Examples of the electron transporting material include quinone compounds such as chloranil and bromanil; tetracyanoquinodimethane compounds; fluorenone compounds such as 2,4,7-trinitrofluorenone, octyl 9-dicyanomethylene-9-fluorenone-4-carboxylate, octyl 9-fluorenone-4-carboxylate, and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)1,3,4-oxadiazole; xanthone compounds; thiophene compounds; dinaphthoquinone compounds such as 3,3′-di-tert-pentyl-dinaphthoquinone; diphenoquinone compounds such as 3,3′-di-tert-butyl-5,5′-dimethyldiphenoquinone and 3,3′,5,5′-tetra-tert-butyl-4,4′-diphenoquinon; and a polymer that has a group formed of any of the above-described compounds in a main chain or a side chain. These electron transporting materials may be used alone or in combination.

Among these, fluorenone compounds may be used to enhance sensitivity. Compounds represented by general formula (1) below may be used among the fluorenone compounds.

The electron transporting materials represented by general formula (1) will now be described.

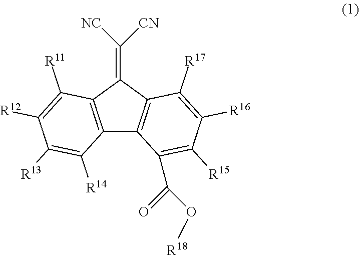

In general formula (1), R¹¹, R¹², R¹³, R¹⁴, R¹⁵, R¹⁶, and R¹⁷ each independently represent a hydrogen atom, a halogen atom, an alkyl group, an alkoxy group, or an aryl group; and R¹⁸ represents a straight-chain alkyl group having from 5 to 10 carbon atoms.

Examples of the halogen atom represented by R¹¹ to R¹⁷ in general formula (1) include a fluorine atom, a chlorine atom, a bromine atom, and an iodine atom.

Examples of the alkyl group represented by R¹¹ to R¹⁷ in general formula (1) include straight-chain or branched alkyl groups having from 1 to 4 carbon atoms (or from 1 to 3 carbon atoms). Specific examples thereof include a methyl group, an ethyl group, a n-propyl group, an isopropyl group, a n-butyl group, and an isobutyl group.

Examples of the alkoxy group represented by R¹¹ to R¹⁷ in general formula (1) include alkoxy groups having from 1 to 4 carbon atoms (or from 1 to 3 carbon atoms). Specific examples thereof include a methoxy group, an ethoxy group, a propoxy group, and a butoxy group.

Examples of the aryl group represented by R¹¹ to R¹⁷ in general formula (1) include a phenyl group and a tolyl group. Among these, a phenyl group may be chosen as the aryl group represented by R¹¹ to R¹⁷.

Examples of the straight-chain alkyl group having 5 to 10 carbon atoms represented R¹⁸ in general formula (1) include a n-pentyl group, a n-hexyl group, a n-heptyl group, a n-octyl group, a n-nonyl group, and a n-decyl group.

Example compounds of the electron transporting material represented by general formula (1) are as follows. However, the electron transporting material is not limited to these. Hereinafter, the example compound of a particular number is referred to as “Example Compound (1-number)”. For example, Example Compound 15 is referred to as “Example Compound (1-15)”.

| Example | | | | | | | | |
|---|---|---|---|---|---|---|---|---|
| Compound | R¹¹ | R¹² | R¹³ | R¹⁴ | R¹⁵ | R¹⁶ | R¹⁷ | R¹⁸ |
| 1 | H | H | H | H | H | H | H | -n-C₇H₁₅ |
| 2 | H | H | H | H | H | H | H | -n-C₈H₁₇ |
| 3 | H | H | H | H | H | H | H | -n-C₅H₁₁ |
| 4 | H | H | H | H | H | H | H | -n-C₁₀H₂₁ |
| 5 | Cl | Cl | Cl | Cl | Cl | Cl | Cl | -n-C₇H₁₅ |
| 6 | H | Cl | H | Cl | H | Cl | Cl | -n-C₇H₁₅ |
| 7 | CH₃ | CH₃ | CH₃ | CH₃ | CH₃ | CH₃ | CH₃ | -n-C₇H₁₅ |
| 8 | C₄H₉ | C₄H₉ | C₄H₉ | C₄H₉ | C₄H₉ | C₄H₉ | C₄H₉ | -n-C₇H₁₅ |
| 9 | CH₃O | H | CH₃O | H | CH₃O | H | CH₃O | -n-C₈H₁₇ |
| 10 | C₆H₅ | C₆H₅ | C₆H₅ | C₆H₅ | C₆H₅ | C₆H₅ | C₈H₅ | -n-C₈H₁₇ |

The abbreviation used in Example Compounds is as follows.

pH: A Phenyl Group

The electron transporting materials represented by general formula (1) may be used alone or in combination. When an electron transporting material represented by general formula (1) is used, it may be used in combination with an electron transporting material other than the electron transporting materials represented by general formula (1).

When electron transporting materials other than the electron transporting materials represented by general formula (1) are used, the content thereof may be 10% by weight or less relative to the total of the electron transporting materials.

The electron transporting material content relative to the total solid content of the photosensitive layer may be 4% by weight or more and 20% by weight or less, 6% by weight or more and 18% by weight or less, or 10% by weight or more and 18% by weight or less.

When two or more electron transporting materials are used in combination, the electron transporting material content is the total content of the electron transporting materials.

### Ratio of Hole Transporting Material to Electron Transporting Material

The ratio of the weight of the hole transporting material to the weight of the electron transporting material (hole transporting material/electron transporting material) may be 50/50 or more and 90/10 or less or 60/40 or more and 80/20 or less.

From the viewpoint of suppressing occurrence of black spots due to cracking of the photosensitive layer, the amount of each component relative to the total solid content of the photosensitive layer may be as follows. For the binder resin, 45% by weight or more and 65% by weight or less; for the charge generating material, 0.5% by weight or more and 5% by weight or less; for the electron transporting material, 10% by weight or more and 20% by weight or less; and for the hole transporting material, 30% by weight or more and 45% by weight or less. The total of all the components is 100% by weight.

### Other Additives

The single-layer-type photosensitive layer may contain other additives such as a surfactant, an antioxidant, a light stabilizer, and a heat stabilizer. When the single-layer-type photosensitive layer constitutes the surface layer, the single-layer-type photosensitive layer may contain fluororesin particles, silicone oil, or the like.

### Formation of Single-Layer-Type Photosensitive Layer

The single-layer-type photosensitive layer is formed by using a photosensitive layer-forming coating solution prepared by adding the above-described component to a solvent.

Examples of the solvent include common organic solvents such as aromatic hydrocarbons such as benzene, toluene, xylene, and chlorobenzene, ketones such as acetone and 2-butanone, halogenated aliphatic hydrocarbons such as methylene chloride, chloroform, and ethylene chloride, and cyclic or straight-chain ethers such as tetrahydrofuran and ethyl ether. These solvents may be used alone or in combination.

Particles (for example, the charge generating material) are dispersed in the photosensitive layer-forming coating solution by using a medium disperser such as a ball mill, a vibrating ball mill, an attritor, a sand mill, or a horizontal sand mill, or a medium-less disperser such as a stirrer, an ultrasonic disperser, a roll mill, or a high-pressure homogenizer. The high-pressure homogenizer may be of a collision type that disperses the dispersion in a high-pressure state through liquid-liquid collision or liquid-wall collision or of a penetration type that prepares dispersion by forcing the dispersion to pass through fine channels in a high pressure state.

Examples of the method for applying the photosensitive layer-forming coating solution include a dip coating method, a lift coating method, a wire bar coating method, a spray coating method, a blade coating method, a knife coating method, and a curtain coating method.

The thickness of the single-layer-type photosensitive layer is set in the range of 5 μm or more and 60 μm or less, 5 μm or more and 50 μm or less, or 10 μm or more and 40 μm or less.

### Other Layers

The photoreceptor according to the exemplary embodiment may include other layers if necessary, as mentioned above. An example of other layers is a protective layer that constitutes the topmost surface layer on the photosensitive layer. The protective layer is provided to prevent chemical changes in the photosensitive layer during charging or further improve mechanical strength of the photosensitive layer, for example. Thus, the protective layer may be a layer formed of a cured film (crosslinked film). Examples of such a layer include layers described in 1) and 2) below.

1) A layer formed of a cured film prepared from a composition that contains a reactive group-containing charge transporting material that has a reactive group and a charge transporting skeleton in the same molecule (in other words, a layer that contains a polymer or crosslinked polymer of the reactive group-containing charge transporting material)
2) A layer formed of a cured film prepared from a composition that contains an unreactive charge transporting material and a reactive group-containing non-charge transporting material that has no charge transporting skeleton but a reactive group (in other words, a layer that contains a polymer or crosslinked polymer of an unreactive charge transporting material and the reactive group-containing non-charge transporting material)

Examples of the reactive group of the reactive group-containing charge transporting material include common reactive groups such as a chain-polymerizable group, an epoxy group, —OH, —OR [where R represents an alkyl group], —NH₂, —SH, —COOH, and —SiR^{Q1}_{3-Qn}(OR^{Q2})_{Qn} [where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain-polymerizable group may be any radical polymerizable functional group. One example is a functional group that has a group that contains at least a carbon-carbon double bond. Specifically, one example is a group that contains at least one selected from a vinyl group, a vinyl ether group, a vinyl thioether group, a styryl group, a vinylphenyl group, an acryloyl group, a methacryloyl group, and derivatives thereof. Among these, a group containing at least one selected from a vinyl group, a styryl group, a vinylphenyl group, an acryloyl group, a methacryloyl group, and derivatives thereof may be used as the chain polymerizable group since it has excellent reactivity.

The charge transporting skeleton of the reactive group-containing charge transporting material may be any structure known to be used in the electrophotographic photoreceptor. Examples thereof include skeletons derived from nitrogen-containing hole transporting compounds, such as triarylamine compounds, benzidine compounds, and hydrazone compounds, and conjugated with nitrogen atoms. Among these, a triarylamine skeleton may be used as the charge transporting skeleton.

The reactive group-containing charge transporting material having a reactive group and a charge transporting skeleton, the unreactive charge transporting material, and the reactive group-containing non-charge transporting material may be selected from known materials.

The protective layer may further contain known additives.

The protective layer is formed by any known method. For example, a coating film is formed by using a protective layer-forming coating solution containing the above-described components and a solvent, dried, and, if needed, heated to be cured.

Examples of the solvent used in preparing the protective layer-forming coating solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents may be used alone or in combination. The protective layer-forming coating solution may be a solvent-less coating solution.

Examples of the method of applying the protective layer-forming coating solution to the photosensitive layer include common methods such as a dip coating method, a lift coating method, a wire bar coating method, a spray coating method, a blade coating method, a knife coating method, and a curtain coating method.

The thickness of the protective layer may be, for example, 1 μm or more and 20 μm or less or 2 μm or more and 10 μm or less.

### Image Forming Apparatus and Process Cartridge

An image forming apparatus according to an exemplary embodiment includes an electrophotographic photoreceptor, a charging device that charges a surface of the electrophotographic photoreceptor, an electrostatic latent image forming device that forms an electrostatic latent image on a charged surface of the electrophotographic photoreceptor, a developing device that develops the electrostatic latent image on the surface of the electrophotographic photoreceptor by using a developer containing a toner so as to form a toner image, and a transfer device that transfers the toner image onto a surface of a recording medium. The electrophotographic photoreceptor according to the exemplary embodiment described above is used as the electrophotographic photoreceptor.

The image forming apparatus according to the exemplary embodiment is applicable to known image forming apparatuses such as an apparatus equipped with a fixing device that fixes a toner image transferred onto a surface of a recording medium, a direct-transfer-type apparatus configured to directly transfer a toner image formed on a surface of an electrophotographic photoreceptor onto a recording medium, an intermediate-transfer-type apparatus configured to transfer a toner image formed on a surface of an electrophotographic photoreceptor onto a surface of an intermediate transfer body (first transfer) and then transfer the toner image on the surface of the intermediate transfer body onto a surface of a recording medium (second transfer), an apparatus equipped with a cleaning device that cleans the surface of an electrophotographic photoreceptor after transfer of the toner image and before charging, an apparatus equipped with a charge erasing device that irradiates a surface of an image supporting body with a charge erasing beam after transfer of a toner image and before charging so as to erase charges, and an apparatus equipped with an electrophotographic photoreceptor-heating member configured to increase the temperature of an electrophotographic photoreceptor and decrease the relative humidity.

For an intermediate-transfer-type apparatus, the transfer device includes, for example, an intermediate transfer body having a surface onto which a toner image is transferred, a first transfer device configured to transfer a toner image on a surface of the image supporting body onto a surface of the intermediate transfer body, and a second transfer device configured to transfer the toner image on the surface of the intermediate transfer body onto a surface of a recording medium.

The image forming apparatus according to the exemplary embodiment may be of a dry development type or a wet development type (development type that uses a liquid developer).

In the image forming apparatus of the exemplary embodiment, the device equipped with the electrophotographic photoreceptor may have a cartridge structure (process cartridge) detachably attachable to the image forming apparatus, for example. An example of the process cartridge is one equipped with the electrophotographic photoreceptor of the exemplary embodiment. The process cartridge may include at least one selected from a charging device, an electrostatic latent image forming device, a developing device, and a transfer device in addition to the electrophotographic photoreceptor.

One non-limiting example of the image forming apparatus of the exemplary embodiment is described below. Only the relevant parts illustrated in the drawings are described and descriptions of other parts are omitted.

FIG. 2 is a schematic diagram illustrating an example of the image forming apparatus according to the exemplary embodiment.

As illustrated in FIG. 2, an image forming apparatus 100 according to the exemplary embodiment includes a process cartridge 300 equipped with an electrophotographic photoreceptor 7, an exposing device 9 (one example of an electrostatic latent image forming device), a transfer device 40 (first transfer device), and an intermediate transfer body 50. In the image forming apparatus 100, the exposing device 9 is located at such a position that the electrophotographic photoreceptor 7 can be exposed through an opening portion of the process cartridge 300, the transfer device 40 is located at a position facing the electrophotographic photoreceptor 7 with the intermediate transfer body 50 therebetween, and a portion of the intermediate transfer body 50 is in contact with the electrophotographic photoreceptor 7. Although not illustrated in the drawing, the image forming apparatus 100 also includes a second transfer device configured to transfer a toner image on the intermediate transfer body 50 onto a recording medium (for example, a sheet of paper). The intermediate transfer body 50, the transfer device 40 (first transfer device), and the second transfer device (not illustrated in the drawing) are examples of the transfer device.

The process cartridge 300 illustrated in FIG. 2 includes the electrophotographic photoreceptor 7, a charging device 8 (an example of a charging device), a developing device 11 (an example of the developing device), and a cleaning device 13 (an example of the cleaning device) that are integrally supported and contained in a housing. The cleaning device 13 includes a cleaning blade (an example of a cleaning member) 131. The cleaning blade 131 is arranged to come into contact with a surface of the electrophotographic photoreceptor 7. The cleaning member may be a conductive or insulating fibrous member instead of or used in combination with the cleaning blade 131.

Although FIG. 2 illustrates an example in which the image forming apparatus is equipped with a fibrous member 132 (roll shape) configured to supply a lubricant 14 to the surface of the electrophotographic photoreceptor 7 and a fibrous member 133 (flat brush shape) that assists cleaning, these components are optional.

Each of the components constituting the image forming apparatus according to the exemplary embodiment will now be described.

### Charging Device

A contact-type charger is used as the charging device 8, for example. Examples of the contact-type charger include those that use a conductive or semi-conductive charge roller, a charging brush, a charging film, a charging rubber blade, or a charging tube. Other known chargers such as a non-contact-type roller charger and scorotron or corotron chargers that utilize corona discharge may also be used.

### Exposing Device

An example of the exposing device 9 is an optical system configured to irradiate a surface of the electrophotographic photoreceptor 7 with light such as semiconductor laser light, LED light, or liquid crystal shutter light so as to form a particular light image. The wavelength of the light source is to be within the spectral sensitivity range of the electrophotographic photoreceptor. The mainstream wavelength of semiconductor lasers is infrared having an oscillation wavelength around 780 nm. However, the wavelength is not limited to this. A laser having an oscillation wavelength on the 600 nm order or a blue laser that has an oscillation wavelength in the range of 400 nm or more and 450 nm or less may be used. Furthermore, a surface emitting laser light source of a type capable of outputting multiple beams for color image formation is also useful.

### Developing Device

Examples of the developing device 11 include common developing devices that conduct contact or non-contact development by using a developer. Any developing device having this function can be used as the developing device 11 and selection may be made according to the purpose. An example thereof is a known developing device configured to apply a single-component developer or two-component developer to the electrophotographic photoreceptor 7 with a brush, a roller, or the like. Specifically, a developing device that uses a developing roller that carries a developer on its surface may be used as the developing device 11.

The developer used in the developing device 11 may be a single-component developer composed of a toner only or a two-component developer that contains a toner and a carrier. The developer may be magnetic or non-magnetic. A known developer may be used as the developer.

### Cleaning Device

The cleaning device 13 is a cleaning-blade-type device equipped with a cleaning blade 131. Alternatively, the cleaning device 13 may be of a fur-brush-cleaning type or a simultaneous development and cleaning type.

### Transfer Device

Examples of the transfer device 40 include various known transfer chargers such as contact-type transfer chargers that use a belt, a roller, a film, a rubber blade, or the like, and scorotron transfer charges and corotron transfer chargers that utilize corona discharge.

### Intermediate Transfer Body

Examples of the intermediate transfer body 50 include belt-shaped intermediate transfer bodies (intermediate transfer belts) that contain semi-conductive polyimide, polyamide imide, polycarbonate, polyarylate, polyester, rubber, and the like. The intermediate transfer body may have a belt shape or a drum shape.

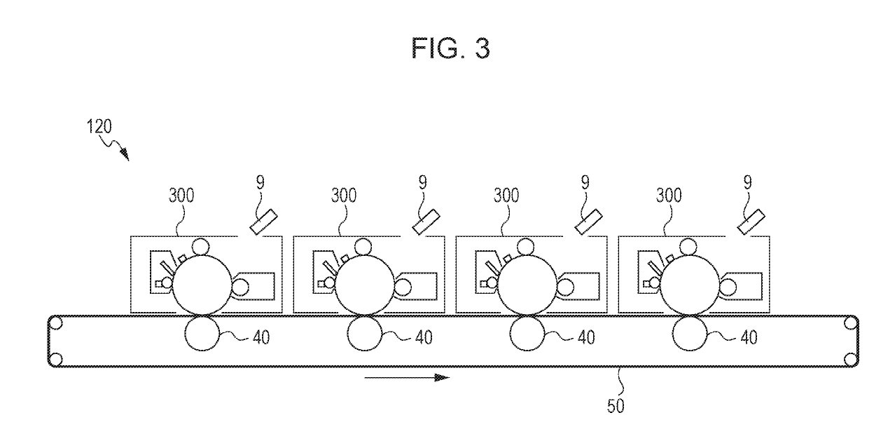

FIG. 3 is a schematic diagram illustrating another example of an image forming apparatus according to the exemplary embodiment.

An image forming apparatus 120 illustrated in FIG. 3 is a tandem-system multicolor image forming apparatus equipped with four process cartridges 300. In the image forming apparatus 120, four process cartridges 300 are arranged side-by-side on the intermediate transfer body 50 and one electrophotographic photoreceptor is used for one color. The image forming apparatus 120 has a structure identical to the image forming apparatus 100 except for that image forming apparatus 120 has a tandem system.

The image forming apparatus 100 according to the exemplary embodiment is not limited to one having the structure described above. For example, a first charge erasing device that aligns polarity of the residual toner so as to facilitate removal of the toner with a cleaning brush may be provided near the electrophotographic photoreceptor and at a position downstream of the transfer device 40 in the rotation direction of the electrophotographic photoreceptor 7 and upstream of the cleaning device 13 in the rotating direction of the electrophotographic photoreceptor 7. Furthermore, a second charge erasing device that erases charges from the surface of the electrophotographic photoreceptor 7 may be provided downstream of the cleaning device 13 in the rotation direction of the electrophotographic photoreceptor and upstream of the charging device 8 in the rotating direction of the electrophotographic photoreceptor.

The structure of the image forming apparatus 100 according to the exemplary embodiment is not limited by the above-described structures. For example, the image forming apparatus 100 may be a direct-transfer-type image forming apparatus configured to directly transfer a toner image formed on the electrophotographic photoreceptor 7 onto a recording medium.

### EXAMPLES

The exemplary embodiments will now be described in specific details through Examples and Comparative Examples but these examples are not limiting. Unless otherwise noted, “parts” means “parts by weight” and “%” means “% by weight”.

### Example 1A

### Formation of Photosensitive Layer

A mixture of 3 parts by weight of a hydroxygallium phthalocyanine pigment serving as a charge generating material shown in Table 1 below, 47 parts by weight of a bisphenol Z polycarbonate resin (viscosity-average molecular weight (Mv): 50,000) serving as a binder resin, 15 parts by weight of an electron transporting material serving as the electron transporting material shown in Table 1 below, 35 parts by weight of a hole transporting material serving as a hole transporting material shown in Table 1, and 250 parts by weight of tetrahydrofuran serving as a solvent is dispersed for 4 hours in a sand mill with glass beads having a diameter of 1 mm. As a result, a photosensitive layer-forming coating solution is obtained.

The photosensitive layer-forming coating solution is applied to an aluminum substrate having a diameter of 30 mm, a length of 244.5 mm, and a thickness of 1 mm by a dip coating method, and dried and cured at 140° C. for 30 minutes. As a result, a single-layer-type photosensitive layer having a thickness of 30 μm is obtained.

Thus, an electrophotographic photoreceptor of Example 1A is made through the above-described steps. The volume resistivity and the elastic modulus of the photosensitive layer of Example 1A are, respectively, 22.1 (GΩ·m) and 4.1 (GPa).

### Examples 2A to 11A

Electrophotographic photoreceptors of respective examples are prepared as in Example 1A except that the type and amount of the binder resin, the type and amount of the charge generating material, the type and amount of the electron transporting material, and the type and amount of the hole transporting material are changed as described in Table 1. In changing the amounts of the components, the amounts (parts) of the materials are adjusted so that the solid content of the photosensitive layer is 100 parts by weight.

### Comparative Example 1A

An electrophotographic photoreceptor of Comparative Example 1A is prepared as in Example 1A except that the type and amount of the binder resin, the type and amount of the charge generating material, the type and amount of the electron transporting material, and the type and amount of the hole transporting material are changed as described in Table 1. The volume resistivity and the elastic modulus of the photosensitive layer of Comparative Example 1A are, respectively, 19 (GΩ·m) and 4.63 (GPa).

### Comparative Example 2A

An electrophotographic photoreceptor of Comparative Example 2A is prepared as in Example 1A except that the type and amount of the binder resin, the type and amount of the charge generating material, the type and amount of the electron transporting material, and the type and amount of the hole transporting material are changed as described in Table 1 and the drying and curing conditions are changed to 150° C., 60 minutes. The volume resistivity and the elastic modulus of the photosensitive layer of Comparative Example 2A are, respectively, 20.5 (GΩ·m) and 4.36 (GPa).

### Example 1B

### Formation of Photosensitive Layer-Forming Coating Solution

A mixture of 3 parts by weight of a hydroxygallium phthalocyanine pigment serving as a charge generating material shown in Table 2 below, 47 parts by weight of a bisphenol Z polycarbonate resin (viscosity-average molecular weight (Mv): 50,000) serving as a binder resin, 13 parts by weight of an electron transporting material serving as the electron transporting material shown in Table 2 below, 37 parts by weight of a hole transporting material serving as a hole transporting material shown in Table 2, and 250 parts by weight of tetrahydrofuran serving as a solvent is dispersed for 4 hours in a sand mill with glass beads having a diameter of 1 mm. As a result, a photosensitive layer-forming coating solution is obtained.

### Preparation of Conductive Substrate S1

An amino-containing silane coupling agent solution is prepared by mixing 10 parts of N-2-(aminoethyl)-3-aminopropylmethyldimethoxysilane and 90 parts of toluene. The amino-containing silane coupling agent solution is spray-coated onto an aluminum substrate having a diameter of 30 mm and a length of 244.5 mm and baked at 135° C. for 60 minutes. As a result, an amino-containing silane coupling agent-treated conductive substrate S1 is obtained.

### Preparation of Photoreceptor

The photosensitive layer-forming coating solution obtained as above is applied to the conductive substrate S1 by a dip coating method and dried and cured at 140° C. for 30 minutes. As a result, a single-layer-type photosensitive layer having a thickness of 30 μm is obtained.

An electrophotographic photoreceptor of Example 1B is prepared through the above-described steps. The volume resistivity and the elastic modulus of the photosensitive layer of Example 1B are, respectively, 22.5 (GΩ·m) and 4.1 (GPa).

### Examples 2B to 11B

Electrophotographic photoreceptors of the respective examples are prepared as in Example 1B except that the type and amount of the binder resin, the type and amount of the charge generating material, the type and mount of the electron transporting material, and the type and amount of the hole transporting material are changed as described in Table 2. In changing the amounts of the components, the amounts (parts) of the materials are adjusted so that the solid content of the photosensitive layer is 100 parts by weight.

### Example 12B

### Preparation of Conductive Substrate S2

An amino-free silane coupling agent-treated conductive substrate S2 is obtained as with the conductive substrate S1 except that vinyltrimethoxysilane is used instead of N-2-(aminoethyl)-3-aminopropylmethyldimethoxysilane.

### Preparation of Photoreceptor

A photosensitive layer-forming coating solution prepared as with the photosensitive layer-forming coating solution of Example 1B is applied to the conductive substrate S2 and dried and cured at 140° C. for 30 minutes. As a result, a single-layer-type photosensitive layer having a thickness of 30 μm is obtained.

### Example 13B

### Preparation of Conductive Substrate S3

An amino-containing silane coupling agent-treated conductive substrate S3 is obtained as with the conductive substrate S1 except that 3-aminopropyltriethoxysilane is used instead of N-2-(aminoethyl)-3-aminopropylmethyldimethoxysilane.

### Preparation of Photoreceptor

A photosensitive layer-forming coating solution prepared as with the photosensitive layer-forming coating solution of Example 1B is applied to the conductive substrate S3 and dried and cured at 140° C. for 30 minutes. As a result, a single-layer-type photosensitive layer having a thickness of 30 μm is obtained.

### Example 14B

### Preparation of Conductive Substrate S4

An amino-containing silane coupling agent-treated conductive substrate S4 is obtained as with the conductive substrate S1 except that N-2-(aminoethyl)-3-aminopropyltrimethoxysilane is used instead of N-2-(aminoethyl)-3-aminopropylmethyldimethoxysilane.

### Preparation of Photoreceptor

A photosensitive layer-forming coating solution prepared as with the photosensitive layer-forming coating solution of Example 1B is applied to the conductive substrate S4 and dried and cured at 140° C. for 30 minutes. As a result, a single-layer-type photosensitive layer having a thickness of 30 μm is obtained.

### Comparative Example 1B

An electrophotographic photoreceptor is prepared as in Example 1B except that the type and amount of the binder resin, the type and amount of the charge generating material, the type and amount of the electron transporting material, and the type and amount of the hole transporting material are changed as indicated in Table 2. The volume resistivity and elastic modulus of the photosensitive layer of Comparative Example 1B are, respectively, 19.5 (GΩ·m) and 4.57 (GPa).

### Evaluation

The electrophotographic photoreceptors obtained are evaluated as follows. The results are shown in Tables 1 and 2.

A 50% halftone image is printed in an initial stage (first sheet) and after printing 30,000 pages using HL5340D produced by Brother Corporation in a 30° C. 80% RH high-temperature, high-humidity environment. Black spots on the images are evaluated based on the following standard.

A rating of 2 or lower means that the image quality is not sufficient for practical application.

### Evaluation Standard

5: No black spots
4: Very few black spots
3: Some black spots are found but they acceptable
2: Black spots are found and they are unacceptable
1: Many black spots are found and they are problematic

TABLE 1

| | Photosensitive layer | | | | | | | |
|---|---|---|---|---|---|---|---|---|
| | | | | | Electron transporting | | Hole transporting | |
| | Binder resin | | Charge generating material | | material | | material | |
| | | Parts by | | Parts by | | Parts by | | Parts by |
| | Type | weight | Type | weight | Type | weight | Type | weight |
| Example 1A | PCZ | 47 | HOGaPc(V) | 3 | 1-1 | 15 | HTM1 | 35 |
| Example 2A | PCZ | 47 | HOGaPc(V) | 3 | 1-2 | 15 | HTM1 | 35 |
| Example 3A | PCZ | 47 | HOGaPc(V) | 3 | 1-3 | 15 | HTM1 | 35 |
| Example 4A | PCZ | 47 | HOGaPc(V) | 3 | 1-4 | 15 | HTM1 | 35 |
| Example 5A | PCZ | 49 | ClGaPc | 3 | 1-1 | 13 | HTM1 | 35 |
| Example 6A | PCZ | 49 | HOGaPc(V)/ClGaPc | 1.5/1.5 | 1-1 | 13 | HTM1 | 35 |
| Example 7A | PCZ | 49 | HOGaPc(V) | 3 | 1-1 | 12 | HTM2 | 36 |
| Example 8A | PCZ | 47 | HOGaPc(V) | 3 | 1-1 | 13 | HTM3 | 37 |
| Example 9A | PCZ | 47 | HOGaPc(V) | 3 | 1-1 | 13 | HTM4 | 37 |
| Example 10A | PCZ-BP | 47 | HOGaPc(V) | 3 | 1-1 | 13 | HTM2 | 37 |
| Example 11A | PCZ-BP | 47 | HOGaPc(V)/ClGaPc | 1.5/1.5 | 1-1 | 13 | HTM2 | 37 |
| Comparative | PCZ | 40 | HOGaPc(V) | 3 | 1-1 | 15 | HTM1 | 42 |
| Example 1A | | | | | | | | |
| Comparative | PCZ | 40 | HOGaPc(V) | 3 | 1-1 | 15 | HTM1 | 42 |
| Example 2A | | | | | | | | |

| | Photosensitive layer | | | Evaluation | |
|---|---|---|---|---|---|
| | | | Elastic | (spot defects) | |
| | Elastic | volume | modulus × | | after |
| | modulus | resistivity | volume | | 30,000 |
| | (GPa) | (GΩ · m) | resistivity | Initial | sheets |
| Example 1A | 4.5 | 20.13 | 90.6 | 5 | 5 |
| Example 2A | 4.52 | 20.24 | 91.5 | 5 | 4 |
| Example 3A | 4.57 | 20.20 | 92.3 | 5 | 4 |
| Example 4A | 4.65 | 20.11 | 93.5 | 4 | 4 |
| Example 5A | 4.69 | 20.15 | 94.5 | 5 | 5 |
| Example 6A | 4.51 | 20.95 | 94.5 | 5 | 5 |
| Example 7A | 4.7 | 20.32 | 95.5 | 5 | 4 |
| Example 8A | 4.48 | 20.13 | 90.2 | 4 | 4 |
| Example 9A | 4.58 | 20.39 | 93.4 | 4 | 4 |
| Example 10A | 4.58 | 20.63 | 94.5 | 5 | 5 |
| Example 11A | 4.58 | 20.87 | 95.6 | 5 | 5 |
| Comparative | 4.4 | 20.00 | 88 | 5 | 1 |
| Example 1A | | | | | |
| Comparative | 4.45 | 20.09 | 89.4 | 5 | 2 |
| Example 2A | | | | | |

TABLE 2

| | | Photosensitive layer | | | | | |
|---|---|---|---|---|---|---|---|
| | | | | | | Electron transporting | |
| | | Binder resin | | Charge generating material | | material | |
| | Conductive | | Parts by | | Parts by | | Parts by |
| | substrate | Type | weight | Type | weight | Type | weight |
| Example 1B | S1 | PCZ | 47 | HOGaPc(V) | 3 | 1-1 | 13 |
| Example 2B | S1 | PCZ | 47 | HOGaPc(V) | 3 | 1-2 | 13 |
| Example 3B | S1 | PCZ | 47 | HOGaPc(V) | 3 | 1-3 | 13 |
| Example 4B | S1 | PCZ | 47 | HOGaPc(V) | 3 | 1-4 | 13 |
| Example 5B | S1 | PCZ | 47 | ClGaPc | 3 | 1-1 | 13 |
| Example 6B | S1 | PCZ | 47 | HOGaPc(V)/ClGaPc | 1.5/1.5 | 1-1 | 13 |
| Example 7B | S1 | PCZ | 47 | HOGaPc(V) | 3 | 1-1 | 13 |
| Example 8B | S1 | PCZ | 47 | HOGaPc(V) | 3 | 1-1 | 13 |
| Example 9B | S1 | PCZ | 47 | HOGaPc(V) | 3 | 1-1 | 13 |
| Example 10B | S1 | PCZ-BP | 47 | HOGaPc(V) | 3 | 1-1 | 13 |
| Example 11B | S1 | PCZ-BP | 47 | HOGaPc(V)/ClGaPc | 1.5/1.5 | 1-1 | 13 |
| Example 12B | S2 | PCZ | 47 | HOGaPc(V) | 3 | 1-1 | 13 |
| Example 13B | S3 | PCZ | 47 | HOGaPc(V) | 3 | 1-1 | 13 |
| Example 14B | S4 | PCZ | 47 | HOGaPc(V) | 3 | 1-1 | 13 |
| Comparative | S1 | PCZ | 40 | HOGaPc(V) | 3 | 1-1 | 15 |
| Example 1B | | | | | | | |

| | |
|---|---|
| Photosensitive layer | Evaluation |

| | Hole transporting | | | | Elastic | (spot defects) | |
|---|---|---|---|---|---|---|---|
| | material | | Elastic | volume | modulus × | | after |
| | | Parts by | modulus | resistivity | volume | | 30,000 |
| | Type | weight | (GPa) | (GΩ · m) | resistivity | Initial | sheets |
| Example 1B | HTM1 | 37 | 4.59 | 20.11 | 92.3 | 5 | 5 |
| Example 2B | HTM1 | 37 | 4.61 | 20.13 | 92.8 | 5 | 5 |
| Example 3B | HTM1 | 37 | 4.63 | 20.11 | 93.1 | 5 | 5 |
| Example 4B | HTM1 | 37 | 4.67 | 20.17 | 94.2 | 5 | 4 |
| Example 5B | HTM1 | 37 | 4.7 | 20.43 | 96 | 5 | 5 |
| Example 6B | HTM1 | 37 | 4.65 | 20.39 | 94.8 | 5 | 5 |
| Example 7B | HTM2 | 37 | 4.7 | 20.66 | 97.1 | 5 | 5 |
| Example 8B | HTM3 | 37 | 4.51 | 20.16 | 90.9 | 5 | 4 |
| Example 9B | HTM4 | 37 | 4.59 | 20.41 | 93.7 | 5 | 4 |
| Example 10B | HTM2 | 37 | 4.71 | 20.21 | 95.2 | 5 | 5 |
| Example 11B | HTM2 | 37 | 4.65 | 20.49 | 95.3 | 5 | 5 |
| Example 12B | HTM1 | 37 | 4.56 | 20.35 | 92.8 | 5 | 5 |
| Example 13B | HTM1 | 37 | 4.57 | 20.37 | 93.1 | 5 | 5 |
| Example 14B | HTM1 | 37 | 4.59 | 20.15 | 92.5 | 5 | 5 |
| Comparative | HTM1 | 42 | 4.44 | 20.07 | 89.1 | 5 | 2 |
| Example 1B | | | | | | | |

Details of the abbreviations used in Tables 1 and 2 are as follows.

### Charge Generating Material

HOGaPc(V): hydroxygallium phthalocyanine (Type V) pigment; a type V hydroxygallium phthalocyanine pigment having diffraction peaks at Bragg's angles (2θ±0.2°) of at least 7.3°, 16.0°, 24.9°, and 28.0° in an X-ray diffraction spectrum taken with a Cu Kα ray (maximum wavelength in an absorption spectrum in the wavelength range of 600 nm or more and 900 nm or less=820 nm, average particle size=0.12 μm, maximum particle size=0.2 μm, specific surface area=60 m²/g)
ClGaPc: chlorogallium phthalocyanine pigment having diffraction peaks at Bragg's angles (2θ±0.2°) of at least 7.4°, 16.6°, 25.5°, and 28.3° in an X-ray diffraction spectrum taken with a Cu Kα ray. Maximum wavelength in an absorption spectrum in the wavelength range of 600 nm or more and 900 nm or less=780 nm, average particle size=0.15 μm, maximum particle size=0.2 μm, BET specific surface area=56 m²/g.

### Electron Transporting Material

1-1: Example Compound (1-1) of an electron transporting material represented by general formula (1)
1-2: Example Compound (1-2) of an electron transporting material represented by general formula (1)
1-3: Example Compound (1-3) of an electron transporting material represented by general formula (1)
1-4: Example Compound (1-4) of an electron transporting material represented by general formula (1)

### Hole Transporting Material

HTM1: hole transporting material HTM1 having the following structure
HTM2: hole transporting material HTM2 having the following structure
HTM3: hole transporting material HTM3 having the following structure
HTM4: hole transporting material HTM4 having the following structure

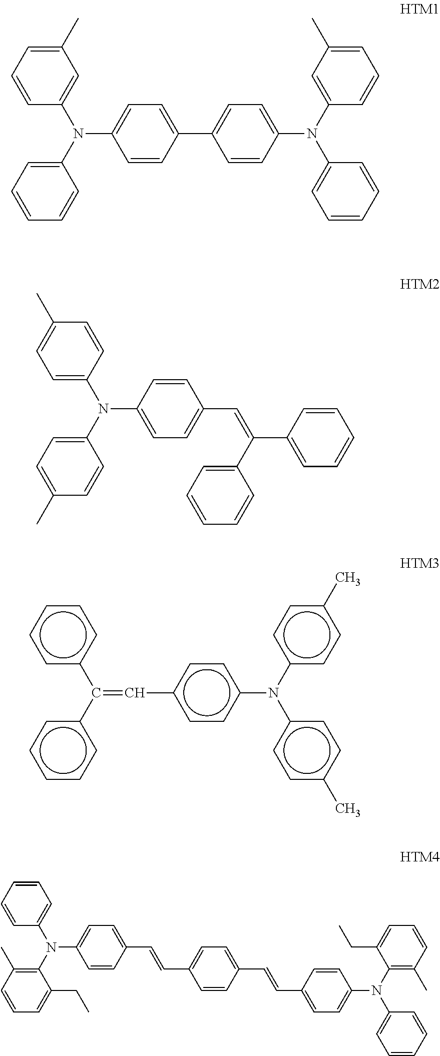

### Binder Resin

PCZ: bisphenol Z polycarbonate resin (homopolymer-type polycarbonate resin of bisphenol Z) (viscosity-average molecular weight (Mv): 50000)
PCZ-BP: biphenyl-copolymer-type polycarbonate resin having a biphenyl skeleton and a bisphenol Z skeleton (biphenyl skeleton/bisphenol Z skeleton ratio (molar ratio)=25/75, viscosity-average molecular weight (Mv): 40000)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a single-layer-type photosensitive layer on the conductive substrate, the single-layer-type photosensitive layer containing a binder resin, a charge generating material, an electron transporting material, and a hole transporting material,
wherein a product of a volume resistivity (GΩ·m) of the single-layer-type photosensitive layer and an elastic modulus (GPa) of the single-layer-type photosensitive layer is about 90 or more.

2. The electrophotographic photoreceptor according to claim 1, wherein the product of the volume resistivity (GΩ·m) and the elastic modulus (GPa) is about 95 or more.

3. The electrophotographic photoreceptor according to claim 1, wherein the volume resistivity (GΩ·m) is about 20 (GΩ·m) or more.

4. The electrophotographic photoreceptor according to claim 1, wherein the elastic modulus (GPa) is about 4.0 (GPa) or more.

5. The electrophotographic photoreceptor according to claim 1, wherein the charge generating material contains at least one selected from a hydroxygallium phthalocyanine pigment and a chlorogallium phthalocyanine pigment.

6. The electrophotographic photoreceptor according to claim 1, wherein the electron transporting material contains an electron transporting material represented by general formula (1) below: 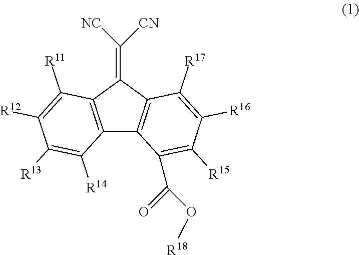
where R¹¹, R¹², R¹³, R¹⁴, R¹⁵, R¹⁶, and R¹⁷ each independently represent a hydrogen atom, a halogen atom, an alkyl group, an alkoxy group, or an aryl group; and R¹⁸ represents a straight-chain alkyl group having from 5 to 10 carbon atoms.

7. The electrophotographic photoreceptor according to claim 1, wherein the binder resin contains a biphenyl-copolymer-type polycarbonate resin containing a structural unit that has a biphenyl skeleton.

8. The electrophotographic photoreceptor according to claim 1, wherein the binder resin is a polycarbonate resin that contains a structural unit represented by general formula (PCA) below and a structural unit represented by general formula (PCB) below: 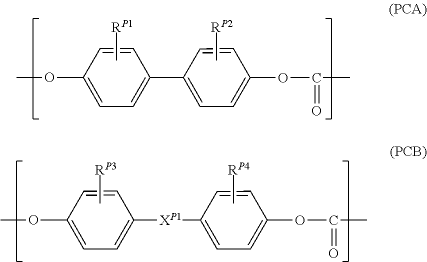
where R^{P1}, R^{P2}, R^{P3}, and R^{P4} each independently represent a hydrogen atom, a halogen atom, an alkyl group having from 1 to 6 carbon atoms, a cycloalkyl group having from 5 to 7 carbon atoms, or an aryl group having from 6 to 12 carbon atoms; and X^{P1} represents a phenylene group, a biphenylene group, a naphthylene group, an alkylene group, or a cycloalkylene group.

9. The electrophotographic photoreceptor according to claim 1, wherein the conductive substrate is an amino-containing silane coupling agent-treated conductive substrate.

10. A process cartridge attachable to and detachable from an image forming apparatus, comprising the electrophotographic photoreceptor according to claim 1.

11. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image on the surface of the electrophotographic photoreceptor by using a developer containing a toner so as to form a toner image; and
a transfer device that transfers the toner image onto a surface of a recording medium.
